(19) United States
(12) Patent Application Publication
(10) Pub. No.: US 2013/0344415 A1
(43) Pub. Date: Dec. 26, 2013

(54) SOLID OXIDE FUEL CELL AND METHOD OF FORMING

(71) Applicant: Aravind Mohanram, Northborough, MA (US)

(72) Inventor: Aravind Mohanram, Northborough, MA (US)

(21) Appl. No.: 13/923,983

(22) Filed: Jun. 21, 2013

Related U.S. Application Data
(60) Provisional application No. 61/663,730, filed on Jun. 25, 2012.

(51) Int. Cl. H01M 8/10

(52) U.S. Cl. CPC H01M 8/1004
USPC 429/482; 429/535

(57) ABSTRACT

A method of forming a solid oxide fuel cell (SOFC) article includes providing a green electrode layer formed by a freeze-casting process and forming a green SOFC unit cell. The green SOFC unit cell includes a green electrolyte layer, a green cathode layer overlying the electrolyte layer, a green interconnect layer, and a green anode layer disposed between the green electrolyte layer and the interconnect layer. The method includes sintering the green SOFC unit cell in a single sintering process to form a sintered SOFC unit cell.

### CROSS-REFERENCE TO RELATED APPLICATION

This application claims priority to U.S. Patent Application No. 61/663,730, entitled “Solid Oxide Fuel Cell and Method of Forming,” naming inventor Aravind Mohanram, filed Jun. 25, 2012, which application is incorporated by reference herein in its entirety.

### BACKGROUND

1. Field of the Disclosure

The following is directed to solid oxide fuel cells (SOFCs) and methods of forming SOFCs.

2. Description of the Related Art

A fuel cell is a device that generates electricity by a chemical reaction. Among various fuel cells, solid oxide fuel cells (SOFCs) use a hard, ceramic compound metal (e.g., calcium or zirconium) oxide as an electrolyte. Typically, in solid oxide fuel cells, an oxygen gas, such as O₂, is reduced to oxygen ions (O²⁻) at the cathode, and a fuel gas, such as H₂ gas, is oxidized with the oxygen ions to form water at the anode.

In some instances, fuel cell assemblies have been designed as stacks, which include a cathode, anode, and solid electrolyte between the cathode and the anode. Each stack can be considered a subassembly, which can be combined with other stacks to form a full SOFC article. In assembling the SOFC article, electrical interconnects can be disposed between the cathode of one stack and the anode of another stack.

However, stacks of individual fuel cells can be susceptible to damage caused by fluctuation in temperature during their formation or use. Specifically, materials employed to form the various components, including ceramics of differing compositions, exhibit distinct material, chemical, and electrical properties that can result in breakdown and failure of the SOFC article. In particular, fuel cells have a limited tolerance for changes in temperature. Problems associated with mechanical stress caused by changes in temperature can be exacerbated when individual fuel cells are stacked Limited thermal shock resistance of fuel cells, particularly of fuel cells assembled in stacks may limit the yield of production, posing a heightened risk of failure during operation.

Moreover, the fabrication of SOFC articles has its own set of concerns. Concerns associated with layering and sintering of the compositionally different layers is one of the most formidable challenges in SOFC manufacturing. Current approaches focus on multi-step firing processes or one step hot-pressing and the use of metallic interconnect materials. The industry continues to demand improved SOFC articles and methods of forming.

### SUMMARY

According to one aspect, a method of forming a solid oxide fuel cell (SOFC) article includes providing a freeze-cast electrode layer formed by a freeze-casting process and forming a green SOFC unit cell. The green SOFC unit cell includes a green electrolyte layer, the freeze-cast electrode layer overlying the electrolyte layer, a green interconnect layer, and a green electrode layer disposed between the green electrolyte layer and the green interconnect layer. The method includes sintering the green SOFC unit cell in a single sintering process to form a sintered SOFC unit cell.

In another aspect, a method of forming a solid oxide fuel cell (SOFC) article includes providing a first electrode layer, where a majority of a porosity of the a first electrode layer comprises a vertical orientation. Each of the pores of the majority have a length and a width, with the length greater than the width, where the dimension of length defines a pore axis. The pore axis forms an angle that is greater than about 45 degrees from a horizontal axis defining a width of the first electrode layer. The method includes forming a green SOFC unit cell that includes a green electrolyte layer, a first green electrode layer overlying the electrolyte layer, a green interconnect layer, and a second green electrode layer disposed between the green electrolyte layer and the interconnect layer, wherein at least one of the first or second green electrode layer includes a pore axis that forms an angle that is greater than about 45 degrees from a horizontal axis defining a width of the at least one green electrode layer. Alternatively, or additionally, the at least one green electrode layer is formed by a freeze-casting process. The method further includes sintering the green SOFC unit cell in a single sintering process to form a sintered SOFC unit cell.

In still another aspect, a solid oxide fuel cell (SOFC) article includes an anode, a cathode, an electrolyte disposed between the anode and the cathode, and an interconnect overlying the anode. The cathode is formed by a freeze-casting process and consists essentially of lanthanum strontium manganite (LSM).

### BRIEF DESCRIPTION OF THE DRAWINGS

The present disclosure may be better understood, and its numerous features and advantages made apparent to those skilled in the art by referencing the accompanying drawings.

FIG. 1 includes an illustration of a SOFC unit cell in accordance with an embodiment.

FIG. 2 includes an illustration of a SOFC unit cell in accordance with an embodiment.

FIG. 3 includes an illustration of a SOFC unit cell in accordance with an embodiment.

FIG. 4 includes an illustration of a SOFC unit cell in accordance with an embodiment.

FIG. 5 includes an illustration of a cross-sectional SEM image of an exemplary freeze-cast electrode layer that is formed by a freeze-casting process.

FIG. 6 includes an illustration of a cross-sectional SEM image of the exemplary freeze-cast electrode layer of FIG. 5 overlying an exemplary electrode functional layer after a sintering operation.

The use of the same reference symbols in different drawings indicates similar or identical items.

### DETAILED DESCRIPTION

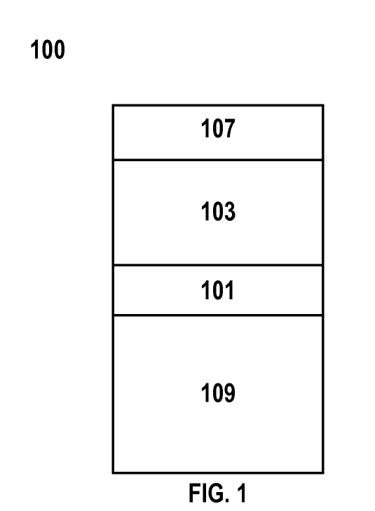

The following describes solid oxide fuel cell (SOFC) articles including SOFC unit cells and methods of forming the SOFC unit cells. FIG. 1 includes an illustration of an SOFC unit cell 100 in accordance with an embodiment. The SOFC unit cell 100 may include at least a first electrode, a second electrode, an electrolyte disposed between the first and second electrodes, and an interconnect overlying at least one of the first or second electrodes. In an embodiment, the first electrode may be a cathode, the second electrode may be an anode, and the interconnect may overly the anode. In a particular embodiment, at least one of the cathode or the anode is formed by a freeze-casting process.

The exemplary SOFC unit cell 100 illustrated in FIG. 1 includes an electrolyte layer 101, an interconnect layer 107, an anode layer 103 disposed between the electrolyte layer 101 and the interconnect layer 107, and a cathode layer 109 overlying the electrolyte layer 101. In the particular embodiment illustrated in FIG. 1, the electrolyte layer 101 is in direct contact with the anode layer 103 and the cathode layer 109, and the interconnect layer 107 is in direct contact with the anode layer 103.

Before assembling the component layers in the unit cell 100 as illustrated in FIG. 1, each of the layers can be formed individually. That is, the layers can be formed separately (e.g., as green layers) and assembled together into the unit cell 100. Alternatively, the layers may be formed (e.g., in green state) in succession on each other. In at least one embodiment, at least one of the electrode layers (e.g. cathode or anode) is formed by a freeze-casting process. In a particular illustrative embodiment, a freeze-cast cathode layer 109 formed by a freeze-casting process may be provided. A green electrolyte layer 101 can be formed overlying the freeze-cast cathode layer 109, thereafter, a green anode layer 103 can be formed overlying the green electrolyte layer 101, and thereafter, a green interconnect layer 107 can be formed overlying the green anode layer 103. In a particular embodiment, the green SOFC unit cell 100 can be sintered in a single sintering process (e.g., a single, free-sintering process) to form a sintered SOFC unit cell.

Reference herein to “green” articles is reference to materials that have not undergone sintering to affect densification or grain growth. A green article is an unfinished article that may be dried and have low water content, but is unfired. A green article can have suitable strength to support itself and other green layers formed thereon.

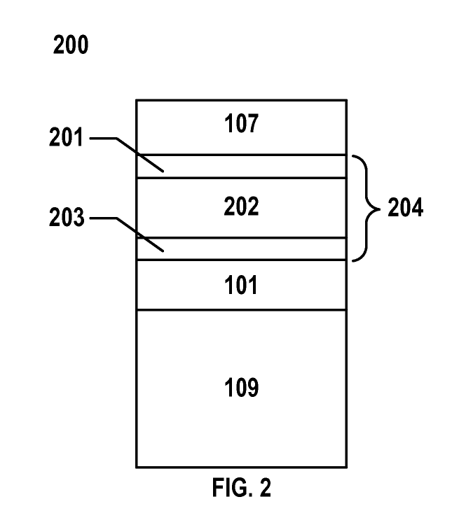

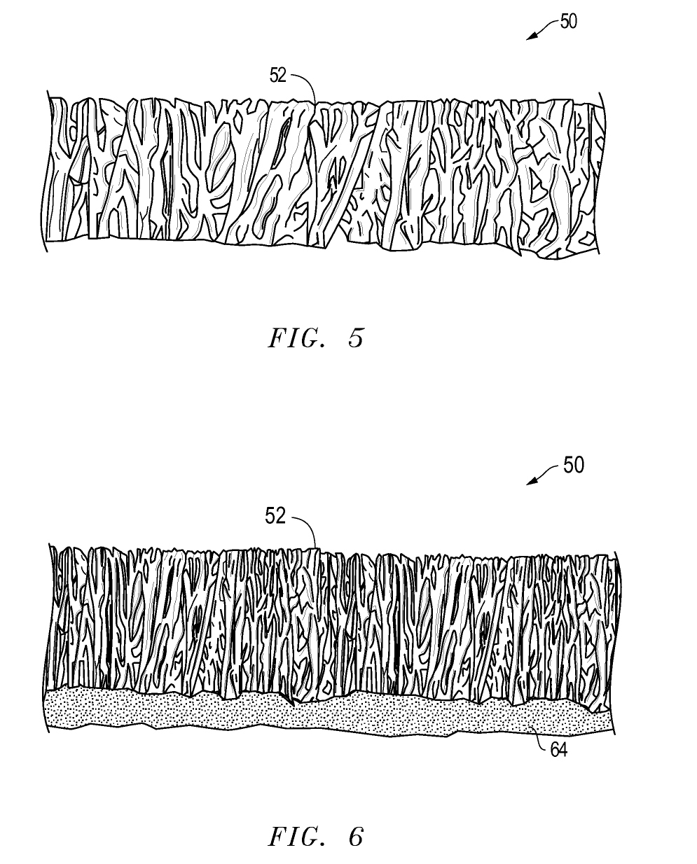

The layers described according to the embodiments herein can be formed through techniques including, but not limited to, casting, deposition, printing, extruding, lamination, die-pressing, gel casting, spray coating, screen printing, roll compaction, injection molding, and a combination thereof. In one particular instance, one or more of the layers can be formed via screen printing. In another embodiment, one or more of the layers can be formed via a tape casting process. The cathode layer 109 may be formed by a freeze-casting process. As an illustrative, non-limiting example, FIG. 5 illustrates an electrode layer 50, such as a cathode layer 109 or an anode layer 103 (see FIG. 1) (or anode layer 202 in FIG. 2), which is formed by a freeze-casting process.

Freeze casting is a process that may be used to produce porous ceramic materials. The process may involve solidifying a solvent in a ceramic slurry to produce a frozen network, subliming the frozen solvent, and sintering the remaining porous powder network. As an illustrative, non-limiting example, the frozen solvent may be ice. Characteristics of a pore network include percent porosity, connectivity of pores, pore shape, size and size distribution, specific surface area, and tortuosity. Directional solidification conditions may have an effect on the orientation of porosity in the freeze cast microstructure. Oriented porosity may improve gas diffusion and reduce tortuosity. Further, with freeze-casting technology, finer powders (higher strength) can be used, and there may be no need for pore formers (simpler burnout and minimal EHS concerns).

In at least one embodiment, at least one electrode layer formed by the freeze-casting process may have a porosity that is not less than about 30 vol % of the total volume of the electrode layer, such as not less than about 40 vol %, not less than about 50 vol %, not less than about 60 vol %, not less than about 65 vol %, or not less than about 70 vol %. Still, the electrode layer formed by the freeze-casting process may have a porosity that is not greater than about 80 vol % of the total volume of the electrode layer, such as not greater than about 85 vol %, or not greater than about 90 vol %. It will be appreciated that the electrode layer formed by the freeze-casting process can have a porosity within a range between any of the minimum and maximum values noted above. In a particular embodiment, the electrode layer formed by the freeze-casting process includes the cathode layer 109.

In a particular embodiment, a majority of a porosity of the electrode layer formed by the freeze casting process may comprise a vertical orientation. For example, FIG. 5 illustrates an exemplary electrode layer, such as a cathode layer 109 or an anode layer 103 (see FIG. 1) (or anode layer 202 in FIG. 2), where a majority of the porosity 52 comprises a vertical orientation. Each of the pores of the majority have a length and a width, where the length is greater than the width. The dimension of length defines a pore axis, and the pore axis forms an angle that is greater than about 45 degrees from a horizontal axis defining a width of the cathode layer 109 or anode layer 103 or 202. In a particular embodiment, the pore axis may form an angle of greater than about 46 degrees from the horizontal axis, such as greater than about 48 degrees, greater than about 50 degrees, greater than about 52 degrees, greater than about 54 degrees, greater than about 56 degrees, greater than about 58 degrees, or greater than about 60 degrees. It will be appreciated that the pore axis may form an angle within a range between any of the minimum and maximum values noted above.

The green SOFC unit cell 100, including an electrode layer (e.g. cathode layer 109 and/or anode layer 103) formed by the freeze-casting process, can be sintered in a single sintering process (e.g., a single, free-sintering process) to form the sintered SOFC unit cell. After the single sintering process of the green SOFC unit cell 100, the porosity of the formed by the freeze-casting process may be reduced. For example, FIG. 5 illustrates an electrode 50 with a porosity 52 before a sintering operation, and FIG. 6 illustrates the electrode 50 with a porosity 52 that has been altered by a sintering operation. For example, after sintering, the sintered electrode layer may have a porosity that is not less than about 30 vol % of the total volume of the sintered electrode layer, such as not less than about 35 vol %, or not less than about 40 vol %. Still, the sintered electrode layer may have a porosity that is not greater than about 70 vol % of the total volume of the sintered electrode layer, such as not greater than about 60 vol %, or not greater than about 50 vol %. In a non-limiting illustrative embodiment, sintering of the electrode layer that is formed by the freeze-casting process results in formation of a sintered electrode layer that has a porosity in a range of between about 40 vol % and about 50 vol % of the total volume of the sintered electrode layer. It will be appreciated that the sintered electrode layer can have a porosity within a range between any of the minimum and maximum values noted above.

In one embodiment, the cathode layer 109 can be made of an inorganic material. Certain suitable inorganic materials can include oxides. The cathode layer 109 can include a rare earth element. In at least one embodiment, the cathode layer 109 can include elements such as lanthanum (La), manganese (Mn), strontium (Sr), and a combination thereof.

In one particular embodiment, materials for the cathode can include lanthanum manganite materials. The cathode can be made of a doped lanthanum manganite material, giving the cathode composition a perovskite type crystal structure. Accordingly, the doped lanthanum manganite material has a general composition represented by the formula, (La₁₋ₓAₓ)_{y}MnO₃₋₈, where the dopant material is designated by “A” and is substituted within the material for lanthanum (La), on the A-sites of the perovskite crystal structure. The dopant material can be selected from alkaline earth metals, lead, or generally divalent cations having an atomic ratio of between about 0.4 and 0.9 Angstroms. As such, according to one embodiment, the dopant material is selected from the group of elements consisting of Mg, Ba, Sr, Ca, Co, Ga, Pb, and Zr. According to a particular embodiment, the dopant is Sr, and the cathode material is a lanthanum strontium manganite material, known generally as LSM.

Referring to the stoichiometry of the doped lanthanum manganite cathode material, according to one embodiment, parameters such as the type of atoms present, the percentage of vacancies within the crystal structure, and the ratio of atoms, particularly the ratio of La/Mn within the cathode material, are provided to manage the formation of conductivity-limiting compositions at the cathode/electrolyte interface during the operation of the fuel cell. The formation of conductivity-limiting compositions reduces the efficiency of the cell and reduces the lifetime of the SOFC. According to one embodiment, the doped lanthanum manganite cathode material comprises (La₁₋ₓAₓ)_{y}MnO₃₋₈, where x is not greater than about 0.5, y is not greater than about 1.0, and the ratio of La/Mn is not greater than about 1.0. The value of x within the doped lanthanum manganite composition represents the amount of dopant substituted for La within the structure. According to one embodiment, x is not greater than about 0.5, such as not greater than about 0.4 or 0.3. Still, the amount of dopant provided within the cathode material may be less, such that x is not greater than about 0.2, or still 0.1, and particularly within a range of between about 0.4 and 0.05.

In a particular embodiment, the dopant material is Sr (an LSM cathode), such that the cathode composition is (La₁₋ₓSrₓ)_{y}MnO₃₋₈, where x is not greater than about 0.5, such as not greater than about 0.4, 0.3, 0.2 or even not greater than about 0.1, and particularly within a range of between about 0.3 and 0.05. A cathode having a dopant concentration as described in the previous embodiments is desirable for reducing the formation of conductivity-limiting compositions at the cathode/electrolyte interface during the operation of the fuel cell.

In further reference to the stoichiometry of the cathode, the value of y in the general formula (La₁₋ₓAₓ)_{y}MnO₃₋₈ represents the percent occupancy of atoms on the A-site within the crystal lattice. Thought of another way, the value of y may also be subtracted from 1.0 and represent the percentage of vacancies on the A-site within the crystal lattice. For the purposes of this disclosure, a doped lanthanum manganite material having a value of y less than 1.0 is termed an “A-site deficient” structure, since the A-sites within the crystal structure are not 100% occupied. According to one embodiment, y is not greater than about 0.95, such as not greater than about 0.90, not greater than about 0.88, or even not greater than about 0.85. In a particular embodiment, the cathode material is LSM (the dopant material is Sr) having a composition of (La₁₋ₓSrₓ)_{y}MnO₃₋₈, and the value of y is not greater than about 1.0, such as not greater than about 0.95, not greater than about 0.93, or even not greater than about 0.90, and particularly within a range of between about 0.70 and 0.99. A cathode having an A-site deficient, doped lanthanum manganite composition, as provided in the previously described embodiments, may be desirable for reducing the formation of conductivity-limiting compositions at the cathode/electrolyte interface during the operation of the fuel cell.

In further reference to the composition of the doped lanthanum manganite cathode material, according to one embodiment, the ratio of La/Mn is not greater than about 1.0. The ratio of La/Mn within the cathode material can be modified by the addition of a dopant (the value of x in the general formula) as well as the creation of A-site vacancies (related to the value of y) within the lanthanum manganite crystal structure. As such, in another embodiment, the ratio of La/Mn is less than 1.0, such as less than about 0.97, 0.95, or even less than about 0.93. According to a particular embodiment, the cathode material is LSM having a general composition of (La₁₋ₓSrₓ)_{y}MnO₃₋₈, where x is not greater than about 0.5, y is not greater than about 1.0, and the ratio of La/Mn is not greater than 1.0. Accordingly, the ratio of La/Mn within the LSM cathode material may be less than about 1.0, such as less than about 0.97, 0.95 or even 0.90. Generally, a ratio of La/Mn of not greater than 1.0, and particularly less than 1.0, may provide a desirable stoichiometric condition that reduces the formation of conductivity-limiting compositions at the cathode/electrolyte interface during operation of the SOFC article. The formation of such conductivity-limiting compositions may reduce the efficiency and the operable lifetime of the SOFC article.

Alternatively, or additionally, the material of the cathode can include a La-ferrite based material. Typically, the La-ferrite based material can be doped with one or more suitable dopants, such as Sr, Ca, Ba, Mg, Ni, Co or Fe. Examples of doped La-ferrite based materials include LaSrCo-ferrite (LSCF) (e.g., La_{1-g}Sr_{q}Co₁₋ⱼFeⱼO₃) where each of q and j independently is equal to or greater than 0.1, and equal to or less than 0.4 and (La═Sr)/(Fe═Co) is in a range of between about 1.0 and about 0.90 (molar ratio). In one specific embodiment, the cathode can include a mixture of a La-manganite and La-ferrite material. For example, the cathode can include a LaSr-manganite (LSM) (e.g., La₁₋ₖSrₖMnO₃) and a LaSrCo-ferrite (LSCF). Common examples include (La_{0.8}Sr_{0.2})_{0.98}Mn_{3+-Δ} (Δ is equal to or greater than zero, and equal to or less than 0.3) and La_{0.6}Sr_{0.4}Co₄₂Fe_{0.8}O₃.

The cathode layer 109 can have an average thickness that is greater than the average thickness of the electrolyte layer 101 or the interconnect layer 107. For example, the cathode layer 109 can have an average thickness of at least about 50 microns, such as at least about 100 microns, at least about 300 microns, at least about 500 microns, at least about 700 microns, or even at least about 1 mm. In another example, the cathode layer 109 can have an average thickness that is not less than about 0.05 mm, such as not less than about 0.10 mm, not less than about 0.15 mm, not less than about 0.20 mm, or not less than about 0.25 mm. Still, the cathode layer 109 can have an average thickness of not greater than about 5 mm, such as not greater than about 2 mm, not greater than about 1.5 mm, or even not greater than about 1 mm. In another example, the cathode layer 109 can have an average thickness that is not greater than about 2 mm, such as not greater than about 1.9 mm, not greater than about 1.8 mm, not greater than about 1.7 mm, not greater than about 1.6 mm, or not greater than about 1.5 mm. It will be appreciated that the cathode layer 109 can have an average thickness within a range between any of the minimum and maximum values noted above.

The electrolyte layer 101 can include an inorganic material, such as a ceramic material. For example, the electrolyte layer 101 can include an oxide material. Some suitable oxides can include zirconia (ZrO₂), and more particularly, zirconia-based materials that can incorporate other elements such as stabilizers or dopants, which can include elements such as yttria (Y), ytterbium (Yb), cerium (Ce), scandium (Sc), samarium (Sm), gadolinium (Gd), lanthanum (La), praseodymium (Pr), neodymium (Nd), and a combination thereof. Particular examples of suitable electrolyte materials can include Sc₂O₃-doped ZrO₂, Y₂O₃-doped ZrO₂, Yb₂O₃-doped ZrO₂, Sc₂O₃-doped and CeO₂-doped ZrO₂, and a combination thereof. The electrolyte layer can also include ceria (CeO₂), and more particularly ceria-based materials, such as Sm₂O₃-doped CeO₂, Gd₂O₃-doped CeO₂, Y₂O₃-doped CeO₂, and CaO-doped CeO₂. The electrolyte material 101 can also include lanthanide-based materials, such as LaGaO₃. The lanthanide-based materials can be doped with particular elements, including but not limited to, Ca, Sr, Ba, Mg, Co, Ni, Fe, and a combination thereof. In particular, the electrolyte material can include a lanthanum strontium manganite (LSM) material. Some exemplary electrolyte materials include La_{0.8}Sr_{0.2}Ga_{0.8}Mn_{0.2}O₃, La_{0.8}Sr_{0.2}Ga_{0.8}Mn_{0.15}Co_{0.5}O₃, La_{0.9}Sr_{0.1}Ga_{0.8}Mn_{0.2}O₃, LaSrGaO₄, LaSrGa₃O₇, or La_{0.9}A_{0.1}GaO₃, wherein A represents one of the elements from the group Sr, Ca, or Ba. According to one particular embodiment, the electrolyte layer 101 can be made of ZrO₂ doped with 8 mol % Y₂O₃ (i.e., 8 mol % Y₂O₃-doped ZrO₂). The 8 mol % Y₂O₃ can have particular dopants, such as Al and/or Mn to facilitate thermal reaction characteristics and improve the processing characteristics of the electrolyte material. Other exemplary electrolyte materials can include doped yttrium-zirconate (e.g., Y₂Zr₂O₇), doped gadolinium-titanate (e.g., Gd₂Ti₂O₂) and brownmillerites (e.g., Ba₂In₂O₆ or Ba₂In₂ O₅.

The electrolyte layer 101 can be a particularly thin, planar layer of material. For example, the electrolyte layer 101 can have an average thickness of not greater than about 1 mm, such as not greater than about 500 microns, such as not greater than about 300 microns, not greater than about 200 microns, not greater than about 100 microns, not greater than about 80 microns, not greater than about 50 microns, or even not greater than about 25 microns. Still, the electrolyte layer 101 can have an average thickness of at least about 1 micron, such as at least about 2 microns, at least about 5 microns, at least about 8 microns, or at least about 10 microns. It will be appreciated that the electrolyte layer 101 can have an average thickness within a range between any of the minimum and maximum values noted above.

The electrolyte layer 101 can be formed via casting, deposition, printing, extruding, lamination, die-pressing, gel casting, spray coating, screen printing, roll compaction, injection molding, and a combination thereof. The electrolyte layer 101 can be formed individually or subsequently to formation of other layers. For example, the electrolyte layer 101 can be formed on one of the other previously-formed layers (e.g., the anode layer 103 or the cathode layer 109). Notably, in a particular embodiment, the formation of the electrolyte layer 101 includes formation of a green layer of material, which is not necessarily sintered before forming a green unit cell 100, which is then sintered in a single sintering process (e.g., a single, free-sintering process).

The electrolyte layer 101 can be formed from a powder electrolyte material having a particular particle size that facilitates formation of a unit cell according to the embodiments herein. For example, the powder electrolyte material can have an average particle size of less than about 100 microns, such as less than about 50 microns, less than about 20 microns, less than about 10 microns, less than about 5 microns, or even less than about 1 micron. Still, in particular instances, the average particle size of the powder electrolyte material can be at least about 0.01 microns, at least about 0.05 microns, at least about 0.08 microns, at least about 0.1 microns, or even at least about 0.2 microns. It will be appreciated that the powder electrolyte material can have an average particle size within a range including any of the minimum and maximum values noted above.

The interconnect layer 107 can include a ceramic material, including an inorganic material. In particular, the interconnect layer 107 can include an oxide material, and more particularly, can be a chromite or nickel oxide material. More particularly, the interconnect layer 107 can include an element selected from the group consisting of lanthanum (La), manganese (Mn), strontium (Sr), titanium (Ti), niobium (Nb), calcium (Ca), gallium (Ga), cobalt (Co), yttria (Y), and a combination thereof. In certain instances, the interconnect layer 107 can include chromium oxide-based materials, nickel oxide-based materials, cobalt oxide-based materials, and titanium oxide-based materials (e.g., lanthanium strontium titanate). In particular, the interconnect layer 107 can be made of a material, such as LaSrCrO₃, LaMnCrO₃, LaCaCrO₃, YCrO₃, LaCrO₃, LaCoO₃, CaCrO₃, CaCoO₃, LaNiO₃, LaCrO₃, CaNiO₃, CaCrO₃, and a combination thereof. In particular, the interconnect layer 107 can comprise LST (or YST), and may consist essentially of Nb doped LST, such as, La_{0.2}Sr_{0.8}TiO_{3,} having one or more dopants. It will be appreciated that the interconnect material may include an A-site deficient material, wherein for example, the lattice sites typically occupied by lanthanum or strontium cations are vacant, and thus the material has a non-stoichiometric composition.

The interconnect layer 107 can be a particularly thin, planar layer of material. For example, the interconnect layer 107 can have an average thickness of not greater than about 1 mm, such as not greater than about 500 microns, not greater than about 300 microns, not greater than about 200 microns, not greater than about 100 microns, not greater than about 80 microns, not greater than about 50 microns, or even not greater than about 25 microns. Still, the interconnect layer 107 can have an average thickness of at least about 1 micron, such as at least about 2 microns, at least about 5 microns, at least about 8 microns, or at least about 10 microns. It will be appreciated that the interconnect layer 107 can have an average thickness within a range between any of the minimum and maximum values noted above.

The interconnect layer 107 can be formed using a process similar to the formation of the electrolyte layer 101, including for example, casting, deposition, printing, extruding, lamination, die-pressing, gel casting, spray coating, screen printing, roll compaction, injection molding, and a combination thereof. The interconnect layer 107 can be formed individually, or subsequently to formation of other layers, such that the interconnect layer 107 can be formed on one of the other previously-formed layers (e.g., the anode layer 103). Notably, in a particular embodiment, the formation of the interconnect layer 107 includes formation of a green layer of material, which is not necessarily sintered before forming a green unit cell 100, which is then sintered in a single sintering process (e.g., a single, free-sintering process).

The electrolyte layer 101 can have a coefficient of thermal expansion (CTE) that may be substantially the same as the CTE of the interconnect layer 107. In particular instances, the CTE of the electrolyte layer 101 can be less than the CTE of the interconnect layer 107.

The interconnect layer 107 can be formed from a powder interconnect material having a particular particle size that facilitates formation of a unit cell according to the embodiments herein. For example, the powder interconnect material can have an average particle size of less than about 100 microns, such as less than about 50 microns, less than about 20 microns, less than about 10 microns, less than about 5 microns, or even less than about 1 micron. Still, in particular instances, the average particle size of the powder interconnect material can be at least about 0.01 microns, at least about 0.05 microns, at least about 0.08 microns, at least about 0.1 microns, at least about 0.2 microns, or even at least about 0.4 microns. It will be appreciated that the powder interconnect material can have an average particle size within a range including any of the minimum and maximum values noted above.

The anode layer 103 disposed between the electrolyte layer 101 and the interconnect layer 107 can also be unsintered (i.e., green). In particular, the anode layer 103 can be in direct contact with the electrolyte layer 101. Additionally, the anode layer 103 can be in direct contact with the interconnect layer 107. In fact, in certain instances, there may not necessarily be any intervening buffer layers between the anode layer 103 and the electrolyte layer 101, or between the anode layer 103 and the interconnect layer 107.

The anode layer 103 can have a CTE that is different than a CTE of the interconnect layer 107. Furthermore, the CTE of the anode layer 103 can be different than the CTE of the electrolyte layer 101. In particular instances, the CTE of the anode layer 103 can be more than the CTE of the electrolyte layer 101. In certain other examples, the CTE of the anode layer 103 can be more than the CTE of the interconnect layer 107.

In particular instances, the anode layer 103 can be a cermet material, that is, a combination of a ceramic and metallic material. Some suitable metals can include transition metal species, including for example, nickel or copper. The anode layer 103 can include an ionic conductor, including for example, a ceramic material, and particularly, an oxide material. For example, the anode layer 103 may be formed with nickel and a zirconia-based material, including for example, yttria-stabilized zirconia. Alternatively, the anode layer 103 can include a ceria-based material, including for example, gadolinium oxide-stabilized ceria. The nickel can be produced through the reduction of nickel oxide included in the anode green material. Alternatively, it will be appreciated that certain other types of oxide materials may be used in the anode layer 103, such as titanates, manganites, chromites, a combination thereof, and the like. It will be appreciated that such oxides may also be perovskite materials.

The anode layer 103 can be a thin and substantially planar layer of material. The anode layer 103 can have an average thickness that is greater than the average thickness of the electrolyte layer 101 or the interconnect layer 107. For example, the anode layer 103 can have an average thickness of at least about 50 microns, such as at least about 100 microns, at least about 300 microns, at least about 500 microns, at least about 700 microns, or even at least about 1 mm. In another example, the anode layer 103 can have an average thickness that is not less than about 0.05 mm, such as not less than about 0.10 mm, not less than about 0.15 mm, not less than about 0.20 mm, or not less than about 0.25 mm. Still, the anode layer 103 can have an average thickness of not greater than about 5 mm, such as not greater than about 2 mm, not greater than about 1.5 mm, or even not greater than about 1 mm. It will be appreciated that the anode layer 103 can have an average thickness within a range between any of the minimum and maximum values noted above.

The anode layer 103 can be formed from a powder electrode material having a particular particle size that facilitates formation of a unit cell according to the embodiments herein. For example, the powder electrode material can have an average particle size of less than about 100 microns, such as less than about 50 microns, less than about 20 microns, less than about 10 microns, less than about 5 microns, or even less than about 1 micron. Still, in particular instances, the average particle size of the powder electrode material can be at least about 0.01 microns, at least about 0.05 microns, at least about 0.08 microns, at least about 0.1 microns, at least about 0.2 microns, or even at least about 0.4 microns. It will be appreciated that the powder electrode material can have an average particle size within a range including any of the minimum and maximum values noted above.

The anode layer 103 can be a porous layer. The porosity may be in the form of channels, which can be utilized to deliver fuel to the SOFC article. The channels may be arranged in a particular manner, such as in a regular and repeating pattern throughout the volume of the anode layer 103. Any suitable techniques may be used to form the porosity and/or channels, including for example, incorporating shaped fugitives, embossing, cutting channels in tapes and then laminating the tapes to define channels, using extrusion through preforms, using patterned rolls in roll compaction. Alternatively, in a particular embodiment, the anode layer 103 may be formed by a freeze-casting process.

There exists a variety of possible materials for fugitives, such as, for example, graphite or fibers that can be used to form the channels or passageways within the cathode and anode layers. The fugitives can be selected from materials that will vaporize or out-gas during heat treatment to form the SOFC article. In one embodiment, the fugitives can be an organic material. Certain suitable examples of fugitives include natural fibers, cotton, bast fibers, cordage fibers, or animal fibers, such as wool. Alternatively, the fugitives can be manufactured material such as, regenerated cellulose, cellulose diacetate, cellulose triacetate, starch, polyimide, polyester, polyacrylic, polyvinyl, polyolefin resins, carbon or graphite fibers, or liquid crystal polymers. The fugitives may also be a binder material, such as synthetic rubber, thermoplastics, or polyvinyl and plasticizer material such as glycol and phthalate groups. In another embodiment, the material can be pasta, such as spaghetti.

According to one embodiment, the SOFC unit cell 100 can include a green interconnect layer 107, a green anode layer 103, a green electrolyte layer 101, and a cathode layer 109 (that is formed by a freeze-casting process). During a lamination step of the green layers, low pressure may be applied uni-axially or isometrically to the SOFC unit cell 100 assist in laminating the green layers together. However, because at least one electrode layer (e.g. the cathode or anode) is formed by a freeze-casting process, it will be appreciated that excessive external pressure is undesirable in that it may tend to damage a freeze-cast electrode. For example, the force applied to the SOFC unit cell 100 during (lamination) is preferably less than about 1000 lb_{f}, such as less than about 750 lb_{f}, less than about 500 lb_{f}, less than about 250 lb_{f}, less than about 100 lb_{f}, less than about 50 lb_{f}, less than about 25 lb_{f}, less than about 15 lb_{f}, even less than about 14.7 lb_{f}.

According to one embodiment, the component layers of the SOFC unit cell 100 may be fired together in a firing process to sinter each of the component layers together and form a unified and integral, co-sintered SOFC unit cell. FIG. 6 illustrates electrode layer 50 of FIG. 5 overlying functional layer 64 after a sintering operation. In one embodiment, the exemplary freeze-cast electrode 50 is a freeze-cast cathode, and the exemplary electrode functional layer 64 is a cathode functional layer. In another embodiment, the exemplary freeze-cast electrode 50 is a freeze-cast anode, and the exemplary electrode functional layer 64 is an anode functional layer. FIG. 6 illustrates that a sintering operation may integrally bond a freeze-cast electrode layer to another layer of an SOFC unit cell in accordance with embodiments of the present invention, such as cathode layer to a cathode functional layer or an anode layer to an interconnect layer, for example, with or without an intervening buffer layer (i.e., a cathode bonding layer or an anode bonding layer). FIG. 6 further illustrates that the majority of the porosity 52 of the exemplary freeze-cast electrode layer 50 of FIG. 5 may remain in a vertical orientation after the sintering operation. The oriented porosity may allow for improved gas diffusion, with reduced tortuosity.

In one particular embodiment, the firing process (i.e., a co-firing process) can be a free-sintering process, where the green SOFC unit cell 100 is fired under ambient pressure. An external mechanical pressure (or force) beyond that of ambient conditions is not necessarily applied to the SOFC unit cell 100 during sintering. Alternatively, for example, the single, free-sintering process may be conducted at a pressure within a range of between about 10⁻²⁰ atm and about 1 atm, such as in a range of between about 10⁻¹⁰ atm and about 1 atm, in a range of between about 10⁻⁴ atm and about 1 atm. In a particular embodiment, the free-sintering process can be conducted at a pressure that is substantially atmospheric pressure taking into account the change in temperature and the atmosphere used during sintering.

In one embodiment, the free-sintering process can include heating the SOFC unit cell 100 to a sintering temperature of at least about 800° C., such as at least about 900° C., at least about 1000° C., or even at least about 1100° C. In certain instances, the sintering temperature can be not greater than about 1500° C., not greater than about 1400° C., or even not greater than about 1300° C. It will be appreciated that the sintering temperature can be within a range between any of the minimum and maximum temperatures noted above.

The free-sintering process can include an isothermal treatment. For example, the SOFC unit cell 100 can be held at the sintering temperature for a particular duration. The duration of isothermal treatment can be at least about 10 minutes, such as at least about 20 minutes, at least about 30 minutes, at least about 40 minutes, at least about 50 minutes, at least about 60 minutes, or even at least about 90 minutes. Still, the duration of isothermal treatment can be not greater than about 600 minutes, such as not greater than about 500 minutes, not greater than about 400 minutes, not greater than about 300 minutes, not greater than about 200 minutes, or even not greater than about 120 minutes. It will be appreciated that the duration of isothermal hold at the sintering temperature can be within a range between any of the minimum and maximum durations noted above.

The free-sintering process may utilize a particular sintering atmosphere. Suitable atmospheres can include inert species, such that reactions with the component layers of the SOFC unit cell 100 are limited. During free-sintering, the atmosphere may be held at a pressure of not greater than about 1 atm. Accordingly, the pressure on the unit cell 100 during isothermal treatment may be within a range between about 10⁻²⁰atm and about 1 atm, such as between about 10⁻¹⁰atm and about 1 atm, or even between about 10⁻⁴ atm and about 1 atm. In other instances, the free-sintering process can be conducted in an atmosphere having a partial pressure of oxygen lower than ambient conditions. In another embodiment, the free-sintering process can include a reducing agent, and more particularly, may be a reducing atmosphere relative to the SOFC unit cell 100.

More particularly, the free-sintering process can be conducted at a sintering temperature, where the electrolyte layer 101 can be in compression and the anode layer 103 can be in tension. Notably, certain characteristics of the green electrolyte layer 101, green anode layer 103, and green interconnect layer 107, including for example, a combination of morphological characteristics, physical characteristics, and chemical characteristics of the material can be used to facilitate the free sintering process and the formation of a unit cell and ultimately a SOFC stack having the characteristics described herein. Without wishing to be tied to a particular theory, it is thought that a combination of characteristics, such as particle size distribution of the powder components, packing factor, porosity, chemical composition of each of the component layers, thermal expansion properties, and the like can facilitate a free-sintering process, where the electrolyte layer 101 is in compression during isothermal treatment.

Notably, the electrolyte layer 101 can have a particular sintering temperature, which can be related to the dimensions of the layer at a particular temperature. For example, according to one embodiment, the electrolyte layer 101 can have an electrolyte sintering temperature different than a sintering temperature of the material of the anode layer 103 (i.e., anode sintering temperature) and different than a sintering temperature of the interconnect layer 107 (i.e., interconnect sintering temperature). In particular instances, the electrolyte layer 101 can have a sintering temperature less than a sintering temperature of the anode layer 103 and less than a sintering temperature of the interconnect layer 107.

In more particular instances, the free-sintering process, and particularly the isothermal hold, can be conducted at a sintering temperature above the electrolyte sintering temperature. That is, for example, the free-sintering temperature can be at a temperature above the electrolyte sintering temperature, and more particularly, below the anode sintering temperature. In another embodiment, free-sintering can be conducted at a temperature above the electrolyte sintering temperature, below the anode sintering temperature and below the interconnect sintering temperature. In still another embodiment, free-sintering according to one embodiment, can be conducted at a temperature above the electrolyte sintering temperature, below the anode sintering temperature, and above the interconnect sintering temperature.

Upon completing the free-sintering process, the interconnect layer 107, anode layer 103, electrolyte layer 101, and cathode layer 109 form an integral SOFC unit cell 100. Additional steps may be undertaken to join additional layers to the integral SOFC unit cell 100 and form a functioning SOFC article.

FIG. 2 includes an illustration of a SOFC unit cell 200 in accordance with an embodiment. The SOFC unit cell 200 can include an electrolyte layer 101, an interconnect layer 107, an anode 204 disposed between the electrolyte layer 101 and the interconnect layer 107, and a cathode layer 109 overlying the electrolyte layer 101. In the particular embodiment illustrated in FIG. 2, the anode 204 includes an anode bonding layer 201, an anode bulk layer 202, and an anode functional layer 203. The anode bonding layer 201 is disposed between the anode bulk layer 202 and the interconnect 107, and the anode functional layer 203 is disposed between the anode bulk layer 202 and the electrolyte 101. Notably, like previously described embodiments, the unit cell 200 can represent a plurality of layers that are stacked together prior to thermal treatment and a plurality of layers integrally formed together after conducting a single sintering process (e.g., a single, free-sintering process).

The anode functional layer 203 can be in direct contact with the electrolyte layer 101. More particularly, the anode functional layer 203 can be directly bonded to the electrolyte layer 101. The anode functional layer 203 can include the same materials as the anode layer 103 described herein. The anode functional layer 203 can facilitate suitable electrical and electrochemical characteristics of the finished SOFC article, and improve electrical and mechanical connection between the anode and the electrolyte.

According to one embodiment, the anode functional layer 203 can be a porous layer, having a porosity within a range between about 20 vol % and about 50 vol %, for the total volume of the anode functional layer 203. The anode functional layer 203 can have an average pore size that is significantly smaller than an average pore size of pores within the anode bulk layer 202.

In particular instances, the green material of the anode functional layer 203 can be formed of a relatively fine agglomerated powder. Alternatively, the powder material may be unagglomerated. The powder can have an average particle size not greater than about 100 microns, such as not greater than about 75 microns, and in certain embodiments, not greater than about 45 microns. Additionally, the powder can be a mixture of agglomerated and unagglomerated powders, wherein the unagglomerated powder may have a notably finer particle size. Such sizes can facilitate formation of suitable pore sizes and grain sizes within the anode functional layer 203.

The anode functional layer 203 can be a thin and substantially planar layer of material, having an average thickness of not greater than about 1 mm, such as not greater than about 700 microns, not greater than about 500 microns, not greater than about 200 microns, not greater than about 150 microns, such as not greater than about 100 microns, or even not greater than about 50 microns. Still, the anode functional layer 203 can have an average thickness of at least about 0.5 microns, such as at least about 1 micron, at least about 5 microns, at least about 10 microns, at least about 15 microns, or even at least about 20 microns. It will be appreciated that the anode functional layer 203 can have an average thickness within a range between any of the minimum and maximum values noted above.

The anode bulk layer 202 can be directly in contact with the anode functional layer 203 and the anode bonding layer 201. More particularly, the anode bulk layer 202 can be directly bonded to the anode functional layer 203 and the anode bonding layer 201. The anode bulk layer 202 can include the same materials as the anode layer 103 described herein.

The anode bulk layer 202 can be a porous layer, having a porosity within a range between about 30 vol % and about 70 vol %, such as not less than about 40 vol %, not less than about 50 vol %, not less than about 60 vol %, not less than about 65 vol %, or not less than about 70 vol % for the total volume of the anode bulk layer 202. The anode bulk layer 202 can have an average pore size that is significantly greater than an average pore size of pores within the anode functional layer 203 or the anode bonding layer 201. In particular, the anode bulk layer 202 can contain channels for delivery of the fuel to the anode 204, and particularly the anode functional layer 203.

The green material of the anode bulk layer 202 can be formed of a generally coarser material than the anode functional layer 203 or the anode bonding layer 201. In particular instances, the anode bulk layer 202 can be formed of an agglomerated powder. The agglomerates may have an average particle size of between about 1 micron and about 300 microns, such as between about 1 micron and about 200 microns, or even between about 1 micron and about 100 microns. In particular embodiments, coarse particles may be used instead of, or in addition to, an agglomerated powder. The coarse particles can have an average particle size within a range between about 0.1 microns and about 100 microns, such as between about 0.1 microns and about 50 microns, or even between about 0.1 microns and about 15 microns.

The anode bulk layer 202 can be a thin and substantially planar layer of material, having an average thickness that is greater than the average thickness of the anode functional layer 203 or the anode bonding layer 201. In particular, the anode bulk layer 202 can have an average thickness not greater than about 2 mm, such as not greater than about 1 mm, or not greater than about 800 microns. Still, the anode bulk layer 202 can have an average thickness of at least about 50 microns, such as at least about 100 microns, at least about 200 microns, or at least about 500 microns. It will be appreciated that the anode bulk layer 202 can have an average thickness within a range between any of the minimum and maximum values noted above.

The anode bonding layer 201 can be directly in contact with the anode bulk layer 202 and the interconnect layer 107. More particularly, the anode bonding layer 201 can be directly bonded to the anode bulk layer 202 and the interconnect layer 107. The anode bonding layer 201 can include the same materials as the anode layer 103 described herein.

The anode bonding layer 201 can be a porous layer, having a porosity within a range between about 0 vol % and about 40 vol %, for the total volume of the anode bonding layer 201. The anode bonding layer 201 can have an average pore size that is significantly less than an average pore size of pores within the anode bulk layer 202. The anode bonding layer 201 can facilitate suitable electrical characteristics of the finished SOFC article, and improve a mechanical connection between the anode and the interconnect layer 107.

The green material of the anode bonding layer 201 can be formed of a generally finer material than the anode bulk layer 202. In particular instances, the green material of the anode bonding layer 201 can be formed of a relatively fine agglomerated powder. The fine agglomerated powder can have an average agglomerate size not greater than about 100 microns, such as not greater than about 75 microns, not greater than about 45 microns, or even not greater than about 20 microns. Still, the average particle size of the fine agglomerated powder can be at least about 0.5 microns, such as at least about 1 micron, or at least about 5 microns. It will be appreciated that the average particle size of the fine agglomerated powder can be within a range between any of the minimum and maximum values noted above. Additionally, the fine agglomerated powder can be mixed with a largely unagglomerated powder, having a notably finer particle size. Alternatively, the fine agglomerated powder may be partially or wholly substituted with unagglomerated particles. The particular sizes of powder material can facilitate formation of suitable pore sizes and grain sizes within the anode bonding layer 201.

The anode bonding layer 201 can be a thin and substantially planar layer of material having an average thickness that is less than the average thickness of the anode bulk layer 202. In particular, the anode bonding layer 201 can have an average thickness of not greater than about 1 mm, such as not greater than about 700 microns, not greater than about 500 microns, or even not greater than about 200 microns. Still, the anode bonding layer 201 can have an average thickness of at least about 1 micron, such as at least about 5 microns, at least about 10 microns, at least about 20 microns, such as at least about 50 microns, at least about 75 microns, at least about 100 microns. It will be appreciated that the anode bonding layer 201 can have an average thickness within a range between any of the minimum and maximum values noted above.

The layers of the SOFC unit cell 200 can be formed according to the embodiments herein, including techniques such as, casting, deposition, printing, extruding, lamination, die-pressing, gel casting, spray coating, screen printing, roll compaction, injection molding, and a combination thereof.

The SOFC unit cell 200 can be formed according to the processes described in the embodiments herein. In particular, the process of forming can include assembling layers of material as illustrated in the SOFC unit cell 200, and conducting a single sintering process (e.g., a single free-sintering process) to form an integral SOFC unit cell 200, where each of the layers are bonded to each other characterized by diffusion bonds at the interfaces of the material layers. Furthermore, it will be appreciated that after sintering to form the integral SOFC unit cell 200, other component layers can be added.

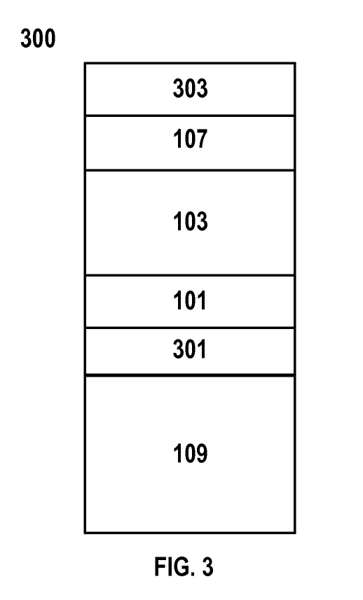

FIG. 3 includes an illustration of a SOFC unit cell 300 in accordance with an embodiment. The SOFC unit cell 300 can include an electrolyte layer 101, an interconnect layer 107, an anode layer 103 disposed between the electrolyte layer 101 and the interconnect layer 107, and a cathode layer 109 overlying the electrolyte layer 101. Additionally, the SOFC unit cell 300 can include a cathode functional layer 301 underlying the electrolyte layer 101. The cathode functional layer 301 can be in direct contact with the electrolyte layer 101. Additionally, the SOFC unit cell 300 can include a cathode bonding layer 303 overlying the interconnect layer 107. The cathode bonding layer 303 can be in direct contact with the interconnect layer 107.

Notably, like previously described embodiments, the SOFC unit cell 300 can represent a plurality of layers that are stacked together prior to thermal treatment. Alternatively, or additionally, the SOFC unit cell 300 can represent a plurality of layers integrally formed together after conducting a single sintering process (e.g., a single, free-sintering process).

According to one embodiment, the cathode functional layer 301 can be a green functional layer portion in direct contact with a green electrolyte layer 101. The cathode functional layer 301 can include the same materials as cathodes described herein. Moreover, the cathode functional layer 301 can include a combination of materials, such as a combination of materials from the cathode layer 109 (e.g., a cathode bulk layer) and the electrolyte layer 101 or interconnect layer 107. For example, the cathode functional layer 301 can include a combination of LSM and YSZ. In a particular embodiment, the cathode functional layer 301 may consist essentially of LSM and YSZ. The cathode functional layer 301 may include not less than about 10 wt % YSZ of the total weight of the cathode functional layer 301, such as not less than about 15 wt % YSZ, or not less than about 20 wt % YSZ. Still, the first cathode functional layer 301 may include not greater than about 70 wt % YSZ, such as not greater than about 65 wt % YSZ, or not greater than about 60 wt % YSZ. It will be appreciated that the cathode functional layer 301 can have a YSZ weight percentage within a range between any of the minimum and maximum values noted above.

The cathode functional layer 301 can have the same characteristics of other functional layers as described herein. Moreover, the cathode functional layer 301 may facilitate suitable electrical characteristics of the finished SOFC article, and improve electrical, electro-chemical, and mechanical connection between the electrolyte and the cathode.

The cathode functional layer 301 can be a thin and substantially planar layer of material having an average thickness that is less than the average thickness of the cathode layer 109 (e.g., the cathode bulk layer). In particular, the cathode functional layer 301 can have an average thickness of not greater than about 1 mm, such as not greater than about 700 microns, not greater than about 500 microns, not greater than about 200 microns, not greater than about 150 microns, such as not greater than about 100 microns, or even not greater than about 50 microns. Still, the cathode functional layer 301 can have an average thickness of at least about 0.5 microns, such as at least about 1 micron, at least about 5 microns, at least about 10 microns, at least about 15 microns, or even at least about 20 microns. It will be appreciated that the cathode functional layer 301 can have an average thickness within a range between any of the minimum and maximum values noted above.

The cathode functional layer 301 can be a porous layer. In a particular embodiment, the green cathode layer 109 may have a porosity (vol %) that is greater than a porosity (vol %) of the green cathode functional layer 301. In a particular embodiment, the green cathode functional layer 301 can have a porosity that is not less than about 10 vol % of the total volume of the green cathode functional layer 301, such as not less than about 15 vol %, or not less than about 20 vol %. Still, the cathode functional layer 301 can have a porosity that is not greater than about 60 vol % of the total volume of the green cathode functional layer, such as not greater than about 55 vol %, or not greater than about 50 vol %. It will be appreciated that the first green cathode functional layer 301 can have a porosity within a range between any of the minimum and maximum values noted above. Further, first cathode functional layer 301 may have an average pore size that is significantly less than an average pore size of pores within the cathode layer 109 (e.g., the cathode bulk layer). It will be appreciated that the cathode bonding layer 303 overlying the interconnect layer 107 can have the same attributes as the cathode functional layer 301.

The layers of the SOFC unit cell 300, and particularly the cathode functional layer 301 and cathode bonding layer 303, can be formed according to the embodiments herein, including techniques such as, casting, deposition, printing, extruding, lamination, die-pressing, gel casting, spray coating, screen printing, roll compaction, injection molding, and a combination thereof.

The SOFC unit cell 300 can be formed according to processes described in the embodiments herein. In particular, the forming of the SOFC unit cell 300 can include assembling layers of material as illustrated into a green SOFC unit cell 300, and conducting a single sintering process (e.g., a single, free-sintering process) to form an integral SOFC unit cell 300. The integral SOFC unit cell 300 is characterized by each of the abutting layers being bonded to each other and forming a diffusion bond region at the interfaces between the material layers. Furthermore, it will be appreciated that after sintering to form the integral SOFC unit cell 300, other component layers can be added.

The formation of the integral SOFC unit cell 300 is particularly desirable since primarily all component layers (i.e., cathode/interconnect/anode/electrolyte) suitable for forming a working SOFC article are formed in a single sintering process (e.g., a single, free-sintering process). Thus, all of the layers can be formed in a single sintering process to form an integrally bonded SOFC unit cell 300 with limited post-processing (i.e., thermal treatment after the sintering process). Additionally, the single sintering process can be completed such that the electrolyte layer 101 is in compression during the isothermal hold at the sintering temperature. The electrolyte layer 101 can also be in compression after completion of the sintering process.

It will further be appreciated that the single sintering process may allow for the cathode layer 109 to be integrally bonded to the cathode functional layer 301 without an intervening buffer layer, such as a cathode bonding layer. However, it should be appreciated that a bonding layer between the cathode layer 109 and the cathode functional layer 301 is considered within the scope of the present invention.

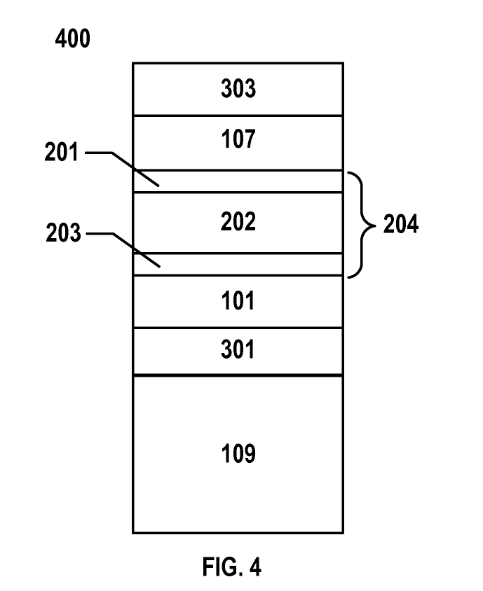

FIG. 4 includes an illustration of a SOFC unit cell 400 in accordance with an embodiment. The SOFC unit cell 400 includes a construction like the SOFC unit cell 200 of FIG. 2 with the addition of cathode functional layer 301 and bonding layer 303 overlying the electrolyte layer 101 and interconnect layer 107, respectively. In particular, the SOFC unit cell 400 includes an electrolyte layer 101, an interconnect layer 107, an anode 204 disposed between the electrolyte layer 101 and the interconnect layer 107, and a cathode functional layer 301 disposed between the cathode layer 109 and the electrolyte layer 101. In particular, the electrolyte layer 101 can be in direct contact with the anode 204, and the interconnect layer 107 can be in direct contact with the anode 204. The anode 204 may comprise a plurality of layers, including an anode functional layer 203, an anode bulk layer 202, and an anode bonding layer 201, having features as described in the other embodiments herein.

The SOFC unit cell 400 also includes a cathode functional layer 301 underlying the electrolyte layer 101. The cathode functional layer 301 can be in direct contact with the electrolyte layer 101. Additionally, the SOFC unit cell 400 can include a cathode bonding layer 303 overlying the interconnect layer 107. The cathode bonding layer 303 can be in direct contact with the interconnect layer 107. According to one embodiment, the cathode functional layer 301 can have any features of cathode functional layers as described in the embodiments herein. Likewise, the cathode bonding layer 303 can have any features of cathode bonding layers as described in the embodiments herein. The cathode functional layer 301 and bonding layer 303 may facilitate suitable electrical characteristics of the finished SOFC article, and improve electrical and mechanical connections.

The SOFC unit cell 400 can be formed according to processes described in the embodiments herein. In particular, forming of the SOFC unit cell 400 can include assembling layers of material as illustrated into a green SOFC unit cell 400, and conducting a single sintering process (e.g., a single, free-sintering process) to form an integral SOFC unit cell 400. The integral SOFC unit cell 400 is characterized by each of the abutting layers being bonded to each other and forming a diffusion bond region at the interfaces between the material layers. Furthermore, it will be appreciated that after sintering to form the integral SOFC unit cell 400, other component layers can be added.

The methods for forming facilitate the formation of integral SOFC unit cells having particular characteristics. For example, according to one embodiment, the electrolyte layer 101 can be in a particular state of compression after forming the SOFC unit cell and after forming the SOFC article. Notably, utilization of the combination of features disclosed herein, including the particular types of materials, ordering of layers, and sintering temperatures facilitates free-sintering formation of SOFC unit cells and SOFC stacks, where the electrolyte layer is in compression. This may result in little to no cracking within the electrolyte layer.

The interconnect layer 107 of a unit cell formed according to an embodiment herein can also exhibit the same limited crack features of the electrolyte layer 101. Accordingly, a unit cell of at least a cathode layer, electrolyte layer, anode layer, and interconnect layer can be formed in a single sintering process (e.g., a single-free sintering process), where the electrolyte layer, anode layer, and interconnect layer demonstrate little to no cracking, which facilitates improved processing and performance.

Additionally, the SOFC unit cells can have a particular bond strength between the anode and the interconnect layer, and between the cathode and the cathode functional layer. According to the methods of forming the SOFC unit cells herein, the anode and the interconnect layer, and the cathode and the cathode functional layer, can be integrally formed and joined by a diffusion bond having an average bond strength of at least about 5% greater than an anode layer and interconnect layer joined separately. In other embodiments, the bond strength can be greater, such as at least about 8%, at least about 10%, at least about 12%, at least about 18%, at least about 25%, at least about 30%, or even at least about 50%.

According to one embodiment, the tensile bond strength between the anode and the interconnect layer, and between the cathode and the cathode functional layer, of the SOFC unit cell can be measured using C633-01 ASTM Standard test for Adhesion or Cohesion Strength. In particular instances, the tensile bond strength can be at least about 15 MPa, such as at least about 20 MPa, at least about 25 MPa, at least about 28 MPa, at least about 30 MPa, at least about 33 MPa, such as at least about 35 MPa, at least about 38 MPa, at least about 40 MPa, at least about 43 MPa,at least about 45 MPa, such as at least about 48 MPa, or even at least about 50 MPa.

Furthermore, the SOFC unit cells can have a particular bond strength between the cathode bonding layer 303 and the interconnect layer 107. According to the methods of forming the SOFC unit cells herein, the cathode bonding layer 303 and the interconnect layer 107 can be integrally formed and joined by a diffusion bond having an average bond strength of at least about 5% greater than a cathode bonding layer and interconnect layer joined separately. In other embodiments, the bond strength can be greater, such as at least about 8%, at least about 10%, at least about 12%, at least about 18%, at least about 25%, at least about 30%, or even at least about 50%.

According to one embodiment, the tensile bond strength between the cathode bonding layer 303 and the interconnect layer 107 can be measured using the method above. In particular instances, the tensile bond strength can be at least about 15 MPa, such as at least about 20 MPa, at least about 25 MPa, at least about 28 MPa, at least about 30 MPa, at least about 33 MPa, such as at least about 35 MPa, at least about 38 MPa, at least about 40 MPa, at least about 43 MPa, at least about 45 MPa, such as at least about 48 MPa, or even at least about 50 MPa.

Furthermore, the SOFC unit cells can have a particular bond strength between the cathode functional layer 301 and the cathode layer 109. According to the methods of forming the SOFC unit cells herein, the cathode functional layer 301 and the cathode layer 109 can be integrally formed and joined by a diffusion bond having an average bond strength of at least about 5% greater than a cathode functional layer and cathode layer joined separately. In other embodiments, the bond strength can be greater, such as at least about 8%, at least about 10%, at least about 12%, at least about 18%, at least about 25%, at least about 30%, or even at least about 50%.

According to one embodiment, the tensile bond strength between the first cathode functional layer 301 and the cathode layer 109 can be measured using the method above. In particular instances, the tensile bond strength can be at least about 15 MPa, such as at least about 20 MPa, at least about 25 MPa, at least about 28 MPa, at least about 30 MPa, at least about 33 MPa, such as at least about 35 MPa, at least about 38 MPa, at least about 40 MPa, at least about 43 MPa, at least about 45 MPa, such as at least about 48 MPa, or even at least about 50 MPa.

Moreover, the SOFC unit cells and SOFC stacks formed according to the embodiments herein demonstrate particularly improved warpage, which is measured as the mid-point deflection, as provided in Malzbender et al., “Curvature of Planar Solid Oxide Fuel Cells during Sealing and Cooling of Stacks”, FUEL CELLS 06, 2006, No. 2, 123-129. For example, the average warpage of the SOFC unit cells according to embodiments herein can be not greater than about 200 microns. Average warpage can be measured using a Micro Measure 3D Surface Profilometer, utilizing a white light chromatic aberration technique, wherein the warpage is measured according to a ISO 4287 standard for defining waviness parameters on a sampling length. The parameters estimated on a sampling length are then averaged on all the available sampling lengths as indicated in the ISO 4288 standard. In one embodiment, the SOFC unit cell can have an average warpage of not greater than about 150 microns, not greater than about 125 microns, not greater than about 100 microns, not greater than about 80 microns, not greater than about 50 microns, not greater than about 40 microns, or even not greater than about 30 microns. In other instances, the average warpage of the SOFC unit cell may be at least about 0.1 microns, at least about 0.5 microns, or even at least about 1 micron. It will be appreciated that the average warpage can be within a range between and including any of the minimum and maximum values noted above.

In a particular embodiment, the SOFC unit cells and the SOFC stacks formed according to the embodiments herein may demonstrate particularly a symmetric structure. For example, a unit cell of at least a cathode layer, electrolyte layer, anode layer, and interconnect layer can be formed in a single sintering process (e.g., a single-free sintering process), where at least one of the cathode and the anode are formed by a freeze-cast process demonstrate little to no warpage, which facilitates improved processing and performance provided the CTE and sintering behavior of the cathode and anode layers are closely matched. The electrolyte layer 101 of the integral SOFC unit cells according to the embodiments can be a particularly dense layer. For example, the density can be at least about 95% theoretical density. In other embodiments, the density can be greater, such as at least about 97%, at least about 98%, or even at least about 99% theoretical density. Accordingly, the porosity of the electrolyte layer 101 can be limited, such as not greater than about 5%, not greater than about 3%, not greater than about 2%, or even not greater than about 1%.

In certain instances, the electrolyte layer 101 of an integral SOFC unit cell according to an embodiment, can have a CTE less than a CTE of the anode layer 103 of the integral SOFC unit cell. According to another embodiment, the interconnect layer 107 can have a CTE less than a CTE of the anode layer 103 of the integral SOFC unit cell.

According to one embodiment, the SOFC unit cells can be formed into operable SOFC stacks as described herein, and demonstrate particular electro-chemical characteristics. For example, the SOFC articles of the embodiments herein can have an open circuit voltage (OCV) of at least about 95% theoretical, wherein open circuit voltage is measured according to the test parameters of 800° C. in 100% H₂. In other instances, the (OCV) can be at least about 95% theoretical, at least about 97% theoretical, or even at least about 98% theoretical. In more particular terms, the testing parameters of OVC include an initial set up and check for air side and fuel side leak rates. If a stack passes the leak test, it is heated up at 2° C./min up to 800° C., while the hydrogen concentration is increased step by step to reduce the presence of NiO. When the OCV is stable at 100% H₂, three measurements of current, voltage, and impedance are taken to generate three I-V curves and impedances plots.

In accordance with one particular embodiment, the operation temperature of the SOFC articles formed herein can be within a range between about 600° C. and about 1000° C.

The embodiments herein represent a departure from the state-of-the-art. While sintering of multiple layers of SOFC stacks has been disclosed (See, for example, U.S. Pat. No. 5,922,486 or U.S. Pat. No. 6,228,520), none of the processes have realized and utilized a sintering process (e.g., a single, free-sintering process) including the combination of features disclosed herein. Notably, according to the embodiments herein, such features include, but are not limited to, particular compositions of the component layers (i.e., cathode, electrolyte, anode, and interconnect), arrangement of the component layers, physical characteristics of the component layers (e.g., thickness and density), sintering temperature as related to the sintering temperature of the component layers, post sintering processing and bonding techniques, warpage, thermal cycling resilience, and the like. Notably, according to embodiments herein, providing a freeze-cast cathode layer (with a particular porosity) may allow for an SOFC unit cell to be formed in a single sintering operation, where the SOFC unit cell includes at least a cathode, electrolyte, anode and interconnect (i.e., a C-E-A-IC unit cell). Further, the oriented porosity and pore structure of the freeze-cast cathode layer may allow for improved gas diffusion between the cathode and electrolyte. The present application discloses a streamlined process for forming a SOFC article including new process features facilitating improved SOFC unit cells and SOFC articles having improved mechanical and electrical characteristics.

### EXAMPLES

FIG. 5 includes a cross-sectional SEM image of an electrode layer 50 that is formed by a freeze-casting process. In a particular embodiment, the exemplary freeze-cast electrode layer 50 may be included in an SOFC unit cell as a cathode bulk layer (e.g., as the cathode layer 109 in FIGS. 1-4) or anode bulk layer (e.g. as the anode layer 103 and 202 of FIGS. 1-4).

FIG. 5 illustrates that directional solidification conditions may have an effect on the orientation of porosity 52 in the freeze cast microstructure. Particularly, a majority of the porosity 52 of the freeze-cast electrode layer comprises a vertical orientation. That is, each of the pores of the majority have a length and a width, with the length greater than the width. The dimension of length defines a pore axis, and the pore axis forms an angle that is greater than about 45 degrees from a horizontal axis defining a width of the green electrode layer.

FIG. 6 includes an illustration of a cross-sectional SEM image of the exemplary freeze-cast electrode layer 50 of FIG. 5 overlying an exemplary electrode functional layer 64 after a sintering operation. In one embodiment, the exemplary freeze-cast electrode 50 is a freeze-cast cathode, and the exemplary electrode functional layer 64 is a cathode functional layer. In another embodiment, the exemplary freeze-cast electrode 50 is a freeze-cast anode, and the exemplary electrode functional layer 64 is an anode functional layer.

FIG. 6 illustrates that a sintering operation may integrally bond a freeze-cast electrode layer to another layer of an SOFC unit cell in accordance with embodiments of the present invention, such as cathode layer to a cathode functional layer or an anode layer to an interconnect layer, for example, without an intervening buffer layer (i.e., a cathode bonding layer or an anode bonding layer). FIG. 6 further illustrates that the majority of the porosity 52 of the exemplary freeze-cast electrode layer 50 of FIG. 5 may remain in a vertical orientation after the sintering operation. The oriented porosity may allow for improved gas diffusion, with reduced tortuosity.

The above-disclosed subject matter is to be considered illustrative, and not restrictive, and the appended claims are intended to cover all such modifications, enhancements, and other embodiments, which fall within the true scope of the present invention. Thus, to the maximum extent allowed by law, the scope of the present invention is to be determined by the broadest permissible interpretation of the following claims and their equivalents, and shall not be restricted or limited by the foregoing detailed description.

The Abstract of the Disclosure is provided to comply with Patent Law and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all features of any of the disclosed embodiments. Thus, the following claims are incorporated into the Detailed Description, with each claim standing on its own as defining separately claimed subject matter.

1. A method of forming a solid oxide fuel cell (SOFC) article, the method comprising:
providing a freeze-cast electrode layer;
forming a green SOFC unit cell, the green SOFC unit cell comprising:
a green electrolyte layer;
a green interconnect layer;
a green electrode layer disposed between the green electrolyte layer and the green interconnect layer; and
the freeze-cast electrode layer overlying the green electrolyte layer; and
sintering the green SOFC unit cell in a single sintering process to form a sintered SOFC unit cell.

2. The method of claim 1, wherein the single sintering process includes a single, free-sintering process conducted at substantially atmospheric pressure.

3. The method of claim 2, wherein the single, free-sintering process includes heating the green SOFC unit cell to a sintering temperature of at least about 800° C. and not greater than about 1500° C.

4. (canceled)

5. (canceled)

6. (canceled)

7. The method of claim 2, wherein the single, free-sintering process includes an isothermal hold of the SOFC unit cell at a sintering temperature for a duration of not less than about 10 minutes and not greater than about 600 minutes.

8. (canceled)

9. The method of claim 1, wherein the freeze-cast electrode layer has a porosity that is not less than about 30 vol % of the total volume of the freeze-cast electrode layer, and not greater than about 80 vol % of the total volume of the freeze-cast electrode layer.

10. (canceled)

11. The method of claim 1, wherein sintering the freeze-cast electrode layer includes sintering an electrode layer having a porosity that is not less than about 30 vol % of the total volume of the cathode layer, and not greater than about 70 vol % of the total volume of the electrode layer.

12. (canceled)

13. (canceled)

14. (canceled)

15. (canceled)

16. The method of claim 15, wherein the freeze-cast electrode layer includes lanthanum strontium manganite (LSM).

17. (canceled)

18. (canceled)

19. The method of claim 1, wherein the green SOFC unit cell further comprises a green cathode functional layer disposed between the freeze-cast electrode layer and the green electrolyte layer.

20. The method of claim 19, wherein the freeze-cast electrode layer has a porosity (vol %) that is greater than a porosity (vol %) of the green cathode functional layer.

21. The method of claim 19, wherein the green cathode functional layer has a porosity that is not less than about 10 vol % of the total volume of the green cathode functional layer, and not greater than about 60 vol % of the totatl volume of the grreen cathode functional layer.

22. (canceled)

23. (canceled)

24. The method of claim 24, wherein the green cathode functional layer includes lanthanum strontium manganite (LSM) and yttria-stabilized zirconia (YSZ).

25. (canceled)

26. (canceled)

27. (canceled)

28. (canceled)

29. (canceled)

30. (canceled)

31. The method of claim 1, wherein the green electrode layer disposed between the green electrolyte layer and the green interconnect layer is a green anode layer, and wherein the green SOFC unit cell further comprises a green anode functional layer disposed between the green anode layer and the green electrolyte layer, and wherein the green SOFC unit cell further comprises a green anode boding layer disposed between the green interconnect layer and the green anode layer.

32. (canceled)

33. (canceled)

34. (canceled)

35. (canceled)

36. (canceled)

37. (canceled)

38. (canceled)

39. (canceled)

40. (canceled)

41. (canceled)

42. A solid oxide fuel cell (SOFC) article, comprising:
an anode;
a cathode consisting essentially of lanthanum strontium manganite (LSM), wherein the cathode is formed by a freeze-casting process;
an electrolyte disposed between the anode and the cathode; and
an interconnect overlying the anode.

43. The SOFC article of claim 42, wherein the cathode has an average thickness that is not less than about 0.05 mm, and not greater than about 2 mm.

44. (canceled)

45. (canceled)

46. (canceled)

47. (canceled)

48. (canceled)

49. The SOFC article of claim 48, wherein the anode comprises yttria-stabilized zirconia.

50. (canceled)

51. (canceled)

52. (canceled)

53. (canceled)

54. (canceled)

55. (canceled)

56. (canceled)

57. The method of claim 1, wherein the freeze-cast electrode layer includes a freeze-cast cathode layer or a freeze-cast anode layer.

58. (canceled)

59. (canceled)

60. (canceled)

61. An SOFC including at least one electrode layer, wherein the at least one electrode layer comprises;
a porosity of not less than about 30 vol % of the total volume of the electrode layer; and
wherein a majority of the porosity of the electrode layer comprises a vertical orientation, wherein each of the pores of the majority have a length and a width, the length greater than the width, wherein the dimension of length defines a pore axis, the pore axis forming an angle that is greater than about 45 degrees from a horizontal axis defining a width of the electrode layer.

62. The SOFC of claim 61, wherein the electrode layer is an anode layer.

63. (canceled)

64. The SOFC of claim 61, wherein the electrode layer is a cathode layer.

65. (canceled)

66. (canceled)

67. (canceled)

68. (canceled)

69. (canceled)

70. (canceled)

71. (canceled)

72. The SOFC of claim 61, further comprising:
an electrolyte layer;
an interconnect layer;
the at least one electrode layer disposed between the electrolyte layer and the interconnect layer;
wherein the at least one electrode layer is disposed directly upon the electrolyte layer; and
wherein the electrolyte layer, the interconnect layer, and the at least one electrode layer are bonded together through a single sintering process to form a sintered SOFC unit cell.

73. (canceled)

74. (canceled)

75. (canceled)
